(19) United States
(12) Patent Application Publication
(10) Pub. No.: US 2020/0192147 A1
(43) Pub. Date: Jun. 18, 2020

(54) DISPLAY PANEL AND DISPLAY DEVICE

(71) Applicant: Wuhan China Star Optoelectronics Technology Co., Ltd., Wuhan (CN)

(72) Inventor: Pengfei YU, Wuhan (CN)

(73) Assignee: Wuhan China Star Optoelectronics Technology Co., Ltd., Wuhan (CN)

(21) Appl. No.: 16/470,554

(22) PCT Filed: Dec. 28, 2018
(86) PCT No.: PCT/CN2018/125009

§ 371 Date: Jun. 18, 2019

(30) Foreign Application Priority Data
Oct. 15, 2018 (CN) 201811193904.5

(51) Int. Cl. G02F 1/1335

(52) U.S. Cl. CPC G02F 1/133512; G02F 2001/133357; G02F 1/133514

(57) ABSTRACT

The present invention provides a display panel and a display device, including a display area and a notch area disposed at one side of the display area; a thickness of a light shielding film in the notch area is less than a thickness of a light shielding film in the display area. By reducing the thickness of the light shielding film in the notch area, good light transmittance of the notch area is kept. Based on this, the notch area does not need to be cut off, which solves the technical problem that the notch area needs to be cut off in the existing display panels.

### BACKGROUND OF INVENTION

### Field of Invention

The present invention relates to a field of liquid crystal displays, and particularly to a display panel and a display device.

### Description of Prior Art

With the development of display technology, full-screen technology with a high screen proportion, a large effective display area, and a better amazing display effect has gradually become mainstream. In order to achieve a full-screen display effect, conventional full-screen terminals need to avoid placing receivers and cameras in display screens, which will affect user experiences.

In order to solve this problem, current technology uses special-shaped screen technology, which forms a notch by cutting a display panel, and then a receiver and a camera are placed in the notch.

Referring to FIG. 1, existing full-screen display panel products usually use a special-shaped cutting method to cut material off a notch area of the display panel. A special-shaped cutting process is added in a process of cutting the display panel, which increases production costs. That is, the existing full-screen display panels have a technical problem that the notch area needs to be cut.

### SUMMARY OF THE INVENTION

The present disclosure provides a display panel and a display device, which can solve the technical problem that the existing full-screen display panels need to cut the notch area.

For the above problem, the present disclosure employs the following technical schemes.

A display panel comprises a display area and a notch area disposed at one side of the display area; a thickness of a light shielding film in the notch area is less than a thickness of a light shielding film in the display area.

In one exemplary embodiment of the display panel, the display panel comprises an array substrate and a color filter disposed opposite to the array substrate; a light shielding mold frame is disposed between the notch area and the display area, and the light shielding mold frame connects with the array substrate and the color filter.

In one exemplary embodiment of the display panel, the notch area of the color filter comprises a transparent substrate and a planarization layer arranged on the transparent substrate.

In one exemplary embodiment of the display panel, the notch area of the array substrate comprises a transparent substrate and a planarization layer arranged on the transparent substrate.

In one exemplary embodiment of the display panel, the notch area of the array substrate comprises a transparent substrate and a buffer layer arranged on the transparent substrate.

In one exemplary embodiment of the display panel, the notch area of the array substrate comprises a transparent substrate, a buffer layer arranged on the transparent substrate and a planarization layer arranged on the buffer layer.

In one exemplary embodiment of the display panel, the notch area of the array substrate comprises a transparent substrate, a buffer layer arranged on the transparent substrate, a transparent conductive layer arranged on the buffer layer and a planarization layer arranged on the transparent conductive layer.

In one exemplary embodiment of the display panel, the transparent conductive layer is patterned to form grid lines.

In one exemplary embodiment of the display panel, the notch area comprises a light transmissive area which is corresponding to a location of an optical device; a plurality of hollow cylinders filled with liquid crystal are disposed in the light transmissive area.

In one exemplary embodiment of the display panel, the display panel also comprises a polyimide layer disposed in the notch area; the polyimide layer fills a remaining space in the notch area except for the light transmissive area.

A display device comprises a display panel and a camera; the display panel comprises a display area and a notch area disposed at one side of the display area; a thickness of a light shielding film in the notch area is less than a thickness of a light shielding film in the display area; the camera is disposed in the notch area along a direction towards to a body of the display device.

In one exemplary embodiment of the display device, the display panel comprises an array substrate and a color filter disposed opposite to the array substrate; a light shielding mold frame is disposed between the notch area and the display area, and the light shielding mold frame connects with the array substrate and the color filter.

In one exemplary embodiment of the display device, the notch area of the color filter comprises a transparent substrate and a planarization layer arranged on the transparent substrate.

In one exemplary embodiment of the display device, the notch area of the array substrate comprises a transparent substrate and a planarization layer arranged on the transparent substrate.

In one exemplary embodiment of the display device, the notch area of the array substrate comprises a transparent substrate and a buffer layer arranged on the transparent substrate.

In one exemplary embodiment of the display device, the notch area of the array substrate comprises a transparent substrate, a buffer layer arranged on the transparent substrate and a planarization layer disposed on the buffer layer.

In one exemplary embodiment of the display device, the notch area of the array substrate comprises a transparent substrate, a buffer layer arranged on the transparent substrate, a transparent conductive layer arranged on the buffer layer and a planarization layer arranged on the transparent conductive layer.

In one exemplary embodiment of the display device, the transparent conductive layer is patterned to form grid lines.

In one exemplary embodiment of the display device, the notch area comprises a light transmissive area which is corresponding to a location of an optical device; a plurality of hollow cylinders filled with liquid crystal are disposed in the light transmissive area; the camera is disposed in the light transmissive area along a direction towards to a body of the display device.

In one exemplary embodiment of the display device, the display panel also comprises a polyimide layer disposed in the notch area; the polyimide layer fills a remaining space in the notch area except for the light transmissive area.

The beneficial effect of the present disclosure is: the present disclosure provides a new display panel and display device, comprising a display area and a notch area disposed at one side of the display area; a thickness of a light shielding film in the notch area is smaller than a thickness of a light shielding film in the display area. By reducing the thickness of the light shielding film in the notch area, good light transmittance of the notch area is kept, and a light transmissive effect made by cutting the notch area off in the existing technology is achieved, thus the notch area does not need to be cut off, which solves the technical problem that the notch area needs to be cut off in the existing display panels and reduces the manufacturing cost of the display panels.

### BRIEF DESCRIPTION OF DRAWINGS

In order to describe clearly the embodiment in the present disclosure or the prior art, the following will introduce the drawings for the embodiment shortly. Obviously, the following description is only a few embodiments, for the common technical personnel in the field it is easy to acquire some other drawings without creative work.

FIG. 1 is a structural diagram of an existing display panel.

FIG. 2 is a structural diagram of a display panel of the present disclosure.

FIG. 3 is a first cross section diagram of the display panel of the present disclosure.

FIG. 4 is a second cross section diagram of the display panel of the present disclosure.

FIG. 5 is a third cross section diagram of the display panel of the present disclosure.

FIG. 6 is a structure diagram of grid lines in the existing display panel.

FIG. 7 is a fourth cross section diagram of the display panel of the present disclosure.

FIG. 8 is a structure diagram of grid lines in the display panel of the present disclosure.

### DETAILED DESCRIPTION OF PREFERRED EMBODIMENTS

The description of following embodiment, with reference to the accompanying drawings, is used to exemplify specific embodiments which may be carried out in the present disclosure. Directional terms mentioned in the present disclosure, such as “top”, “bottom”, “front”, “back”, “left”, “right”, “inside”, “outside”, “side”, etc., are only used with reference to the orientation of the accompanying drawings. Therefore, the used directional terms are intended to illustrate, but not to limit, the present disclosure. In the drawings, the components having similar structures are denoted by same numerals.

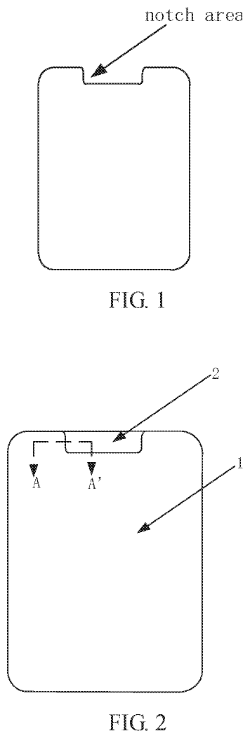

For a technology problem as shown in FIG. 1 that existing full-screen display panels need to cut a notch area off, the present disclosure as shown in FIG. 2 realizes a light transmissive effect of the notch area by reducing light shielding films in the notch area, so as to solve the technology problem.

In one embodiment as shown in FIG. 2, the present disclosure provides a display panel, comprising a display area 1 and a notch area 2 disposed at one side of the display area 1. A thickness of a light shielding film in the notch area 2 is less than a thickness of a light shielding film in the display area.

The present disclosure provides the display panel and a display device, comprising the display area and the notch area disposed at one side of the display area; a thickness of the light shielding film in the notch area is smaller than a thickness of the light shielding film in the display area. By reducing the thickness of the light shielding film in the notch area, good light transmittance of the notch area is kept, and a light transmissive effect made by cutting the notch area off in the existing technology is achieved, thus the notch area does not need to be cut off, which solves the technical problem that the notch area needs to be cut off in the existing display panels and reduces the manufacturing cost of the display panels.

The present disclosure is described below in conjunction with a plurality of cross section diagrams of a selected position in FIG. 2.

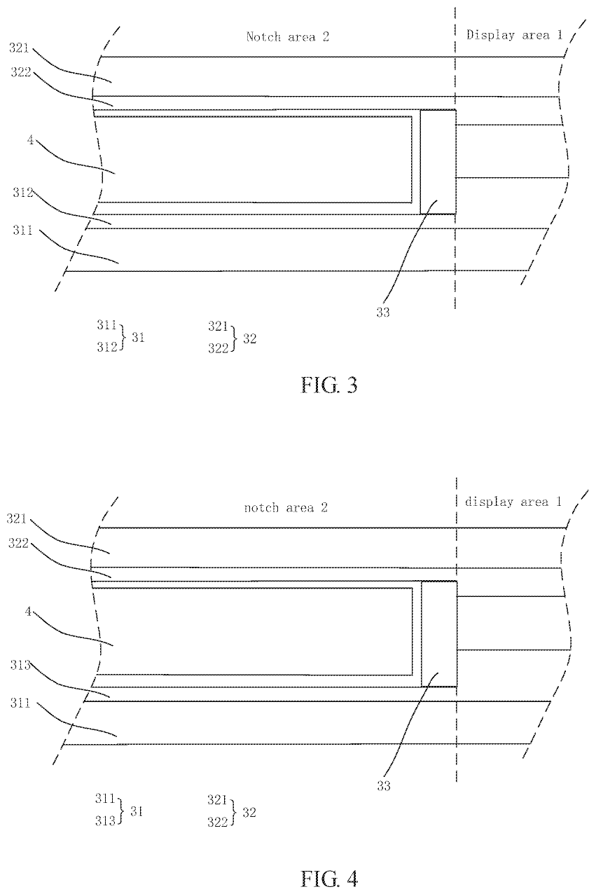

In one embodiment as shown in FIG. 3, the display panel comprises an array substrate 31 and a color filter 32 disposed opposite to the array substrate 31. A light shielding mold frame 33 is disposed between the notch area 2 and the display area 1, and the light shielding mold frame 33 connects with the array substrate 31 and the color filter 32.

In one embodiment, the light shielding mold frame 33 is a light shielding mold frame of thermoplastic-optical clear film (ODF) to avoid liquid crystal in the display area spillover into the notch area.

In one embodiment, the display panel also comprises a photoresist layer fitted to the light shielding mold frame 33. For example, a bottom bezel or left bezel or right bezel of the notch area is blocked by a black matrix (BM) to avoid light leakage from the display area to the notch area.

In one embodiment, the display panel can reduce a thickness of the light shielding film (such as, a light shielding layer, or R/G/B layer or BM layer) in the notch area to make the thickness of the light shielding film in the notch area be less than a thickness of the light shielding film in the display area. The display panel can also dispose no light shielding films in the notch area to make the thickness of the light shielding film in the notch area be less than the thickness of the light shielding film in the display area.

In one embodiment as shown in FIG. 3, the notch area 2 of the color filter 32 comprises a transparent substrate 321 disposed in the notch area 2 and a planarization layer 322 arranged on the transparent substrate 321. In one embodiment, the transparent substrate 321 can be a glass substrate, and the planarization layer 322 can be an over coating (OC) layer.

In one embodiment as shown in FIG. 3, the display panel also comprises a polyimide layer 4 disposed in the notch area 2. The polyimide layer 4 fills the notch area 2. In one embodiment, the polyimide layer 4 comprises a polyimide (PI) layer.

In one embodiment as shown in FIG. 3, the notch area 2 of the array substrate 31 comprises a transparent substrate 311 disposed in the notch area 2 and a planarization layer 312 arranged on the transparent substrate 311. In one embodiment, the transparent substrate 311 can be a glass substrate.

In one embodiment as shown in FIG. 4, the notch area 2 of the array substrate 31 comprises the transparent substrate 321 disposed in the notch area 2 and a buffer layer 313 arranged on the transparent substrate 321. In one embodiment, the buffer layer 313 can be a gate insulator (GI) layer.

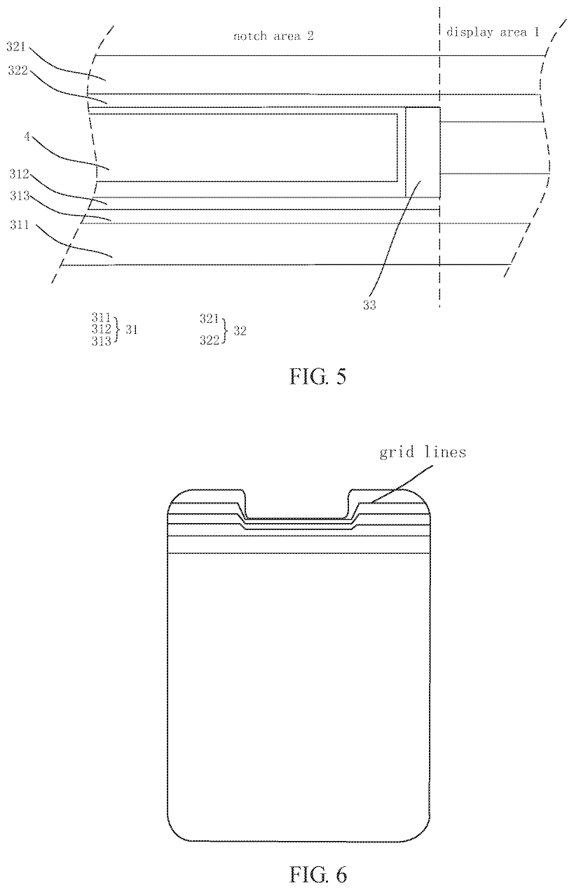

In one embodiment as shown in FIG. 5, the notch area 2 of the array substrate 31 comprises the transparent substrate 311 disposed in the notch area 2, the buffer layer 313 arranged on the transparent substrate and the planarization layer 312 arranged on the buffer layer.

Existing display panel products need to cut material in the notch area of the display panel off, thus making lines, such as grid lines on both sides of the notch area shown in FIG. 6, need to bypass the notch area. This kind of lines design will result in problems that a risk of a short-circuit on both sides of the notch area increases and uneven display happens. The present disclosure can also solve the problems.

In one embodiment as shown in FIG. 7, the notch area 2 of the array substrate 31 comprises the transparent substrate 311 in the notch area 2, the buffer layer 313 arranged on the transparent substrate, a conductive layer 314 arranged on the buffer layer and the planarization layer 312 arranged on the conductive layer. In one embodiment, the conductive layer 314 is a transparent conductive layer, such as indium tin oxide (ITO).

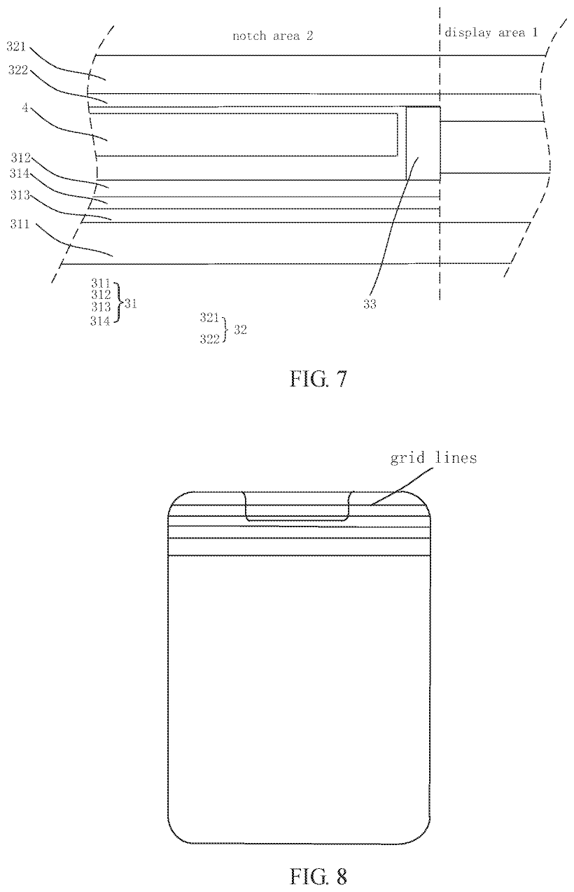

In one embodiment as shown in FIG. 8, the conductive layer 314 is patterned to form signal lines, such as grid lines, thus making the grid lines be able to go straight through the notch area 2 instead of bypassing, and avoiding the risk of the short-circuit on both sides of the notch area and the uneven display.

In one embodiment, the conductive layer 314 is patterned to form an anti-static circuit.

In one embodiment, the notch area 2 comprises a light transmissive area which is corresponding to a location of an optical device (such as, a camera or light sensor). A plurality of hollow cylinders filled with light transmissive material are disposed in the light transmissive area. In one embodiment, the light transmissive material comprises liquid crystal.

In one embodiment, the array substrate 31 and the color filter 32 only comprise the transparent substrates in the light transmissive area, and the plurality of hollow cylinders are directly disposed between the two transparent substrates, avoiding light transmissive material flowing into the notch area 2.

In one embodiment, the display panel also comprises the polyimide layer disposed in the notch area 2. The polyimide layer fills a remaining space in the notch area 2 except for the light transmissive area.

In one embodiment, the present disclosure provides a display device, comprising the display panel shown in the above embodiments and functional components (e.g. earphones, cameras, and light sensors, etc.). The functional components are disposed under the notch area 2. With the display panel, the manufacturing cost of the display device is reduced greatly, and problems of the risk of the short-circuit and uneven display are also alleviated at the same time.

In one embodiment, the present disclosure provides a display device, comprising a display panel and a camera. The display panel comprises a display area and a notch area disposed at one side of the display area. A thickness of a light shielding film in the notch area is less than a thickness of a light shielding film in the display area. The camera is disposed in the notch area along a direction towards to a body of the display device.

The present disclosure provides a display device, comprising the display panel shown in the above embodiments and functional components (e.g. earphones, cameras and light sensors, etc.). The functional components are disposed under the notch area. With the display panel, manufacturing cost of the display device reduces greatly, and problems of the risk of the short-circuit and uneven display are also alleviated at the same time.

In one embodiment, the display panel comprises an array substrate and a color filter disposed opposite to the array substrate; a light shielding mold frame is disposed between a notch area and a display area, and the light shielding mold frame connects with the array substrate and the color filter.

In one embodiment, the notch area of the color filter comprises a transparent substrate and a planarization layer arranged on the transparent substrate.

In one embodiment, the notch area of the array substrate comprises a transparent substrate and a planarization layer arranged on the transparent substrate.

In one embodiment, the notch area of the array substrate (not shown in the FIGs) comprises a transparent substrate and a buffer layer arranged on the transparent substrate.

In one embodiment, the notch area of the array substrate comprises the transparent substrate, the buffer layer arranged on the transparent substrate, and a planarization layer disposed on the buffer layer.

In one embodiment, the notch area of the array substrate comprises the transparent substrate, the buffer layer arranged on the transparent substrate, a transparent conductive layer arranged on the buffer layer, and the planarization layer arranged on the transparent conductive layer.

In one embodiment, the transparent conductive layer is patterned to form grid lines.

In one embodiment, the notch area comprises a light transmissive area which is corresponding to a location of an optical device; a plurality of hollow cylinders filled with liquid crystal are disposed in the light transmissive area; the camera is disposed in the light transmissive area along a direction towards to a body of the display device.

In one embodiment, the display panel also comprises a polyimide layer disposed in the notch area; the polyimide layer fills a remaining space in the notch area except for the light transmissive area.

As shown in the above embodiments, the present disclosure provides a new display panel and display device, comprising a display area and a notch area disposed at one side of the display area; a thickness of a light shielding film in the notch area is smaller than a thickness of a light shielding film in the display area. By reducing the thickness of the light shielding film in the notch area, good light transmittance of the notch area is kept, and a light transmissive effect made by cutting the notch area off in the existing technology is achieved, thus the notch area does not need to be cut off, which solves the technical problem that the notch area needs to be cut off in the existing display panels and reduces the manufacturing cost of the display panels.

In conclusion, the present disclosure is described in detail in accordance with the above contents with the specific preferred examples. However, this present disclosure is not limited to the specific examples. For a person of ordinary skill in the art, on the premise of keeping the conception of the present disclosure, the technical personnel can also make simple deductions or replacements, all of which should be considered to belong to the protection scope of the present disclosure.

What is claimed is:

1. A display panel, comprising a display area and a notch area disposed at one side of the display area; a thickness of a light shielding film in the notch area is less than a thickness of a light shielding film in the display area.

2. The display panel of claim 1, wherein the display panel comprises an array substrate and a color filter disposed opposite to the array substrate; a light shielding mold frame is disposed between the notch area and the display area, and the light shielding mold frame connects with the array substrate and the color filter.

3. The display panel of claim 2, wherein the notch area of the color filter comprises a transparent substrate and a planarization layer arranged on the transparent substrate.

4. The display panel of claim 2, wherein the notch area of the array substrate comprises a transparent substrate and a planarization layer arranged on the transparent substrate.

5. The display panel of claim 2, wherein the notch area of the array substrate comprises a transparent substrate and a buffer layer arranged on the transparent substrate.

6. The display panel of claim 2, wherein the notch area of the array substrate comprises a transparent substrate, a buffer layer arranged on the transparent substrate and a planarization layer arranged on the buffer layer.

7. The display panel of claim 2, wherein the notch area of the array substrate comprises a transparent substrate, a buffer layer arranged on the transparent substrate, a transparent conductive layer arranged on the buffer layer and a planarization layer arranged on the transparent conductive layer.

8. The display panel of claim 7, wherein the transparent conductive layer is patterned to form grid lines.

9. The display panel of claim 1, wherein the notch area comprises a light transmissive area which is corresponding to a location of an optical device; a plurality of hollow cylinders filled with liquid crystal are disposed in the light transmissive area.

10. The display panel of claim 9, wherein the display panel also comprises a polyimide layer disposed in the notch area; the polyimide layer fills a remaining space in the notch area except for the light transmissive area.

11. A display device, comprising a display panel and a camera; the display panel comprises a display area and a notch area disposed at one side of the display area; a thickness of a light shielding film in the notch area is less than a thickness of a light shielding film in the display area; the camera is disposed in the notch area along a direction towards to a body of the display device.

12. The display device of claim 11, wherein the display panel comprises an array substrate and a color filter disposed opposite to the array substrate; a light shielding mold frame is disposed between the notch area and the display area, and the light shielding mold frame connects with the array substrate and the color filter.

13. The display device of claim 12, wherein the notch area of the color filter comprises a transparent substrate and a planarization layer arranged on the transparent substrate.

14. The display device of claim 12, wherein the notch area of the array substrate comprises a transparent substrate and a planarization layer arranged on the transparent substrate.

15. The display device of claim 12, wherein the notch area of the array substrate comprises a transparent substrate and a buffer layer arranged on the transparent substrate.

16. The display device of claim 12, wherein the notch area of the array substrate comprises a transparent substrate, a buffer layer arranged on the transparent substrate and a planarization layer disposed on the buffer layer.

17. The display device of claim 12, wherein the notch area of the array substrate comprises a transparent substrate, a buffer layer arranged on the transparent substrate, a transparent conductive layer arranged on the buffer layer and a planarization layer arranged on the transparent conductive layer.

18. The display device of claim 17, wherein the transparent conductive layer is patterned to form grid lines.

19. The display device of claim 11, wherein the notch area comprises a light transmissive area which is corresponding to a location of an optical device; a plurality of hollow cylinders filled with liquid crystal are disposed in the light transmissive area; the camera is disposed in the light transmissive area along a direction towards to a body of the display device.

20. The display device of claim 19, wherein the display panel also comprises a polyimide layer disposed in the notch area; the polyimide layer fills a remaining space in the notch area except for the light transmissive area.
